(19) United States
(12) Patent Application Publication
(10) Pub. No.: US 2015/0270579 A1
(43) Pub. Date: Sep. 24, 2015

(54) Energy Storage Apparatus and Method

(71) Applicant: Julian Devante, Toronto (CA)

(72) Inventor: Julian Devante, Toronto (CA)

(21) Appl. No.: 14/600,979

(22) Filed: Jan. 20, 2015

Related U.S. Application Data
(60) Provisional application No. 61/969,685, filed on Mar. 24, 2014.
(60) Provisional application No. 61/978,495, filed on Apr. 11, 2014.

(51) Int. Cl. H01M 10/26; H01M 4/64; H01M 10/04; H01M 10/28

(52) U.S. Cl. CPC H01M 10/26; H01M 10/28; H01M 4/64; H01M 10/04; H01M 2300/0014; H01M 2300/0085; H01M 2220/20

(57) ABSTRACT

An alkaline electrolyte comprising at least a synthesized molecular-mesh of starches infused with transition metal oxide nano-tubes is described. In particular the transition metal oxide may comprise titanium dioxide and the starches may comprise modified or reticulated starches. Batteries and electrochemical cells employing the electrolyte are described. A method of synthesizing the transition metal oxide nano-tubes is described. Methods of making positive and negative nano-composite based active materials such as nano-composite based active inks are described, as are electrochemical energy storage devices including the positive and negative nano-composite based active materials.

### CROSS-REFERENCE TO RELATED APPLICATION(S)

This document claims priority to, and the benefit of, U.S. Non-Provisional Patent Application Nos. 61/969,685 filed on Mar. 24, 2014, and 61/978,495 filed on Apr. 11, 2014 herein incorporated by reference in its entirety for all purposes.

### FIELD OF THE INVENTION

The present invention relates generally to energy storage. The present invention further relates to apparatuses, methods, and materials for storing energy.

### BACKGROUND OF THE INVENTION

Energy storage devices, or batteries, exist in many forms. Batteries may include toxic materials, or materials that may only be mined from a limited number of places on Earth. In particular, electrolytes used in batteries may be costly, may exhibit low mechanical strength over a wide temperature range, and may be prone to expansion and swelling.

In addition, the power grid is not able to handle peak loads as demand sky rockets in growing cities. Peak loads may lead to black outs and damage to electrical infrastructure. Renewable energy from wind, solar, and/or geothermal sources is intermittent. This intermittency makes using energy from these sources of energy often impractical for direct use. In fact, large scale wind and solar farms connected to the electrical grid may cause damage and interrupt normal operations, including affecting power quality.

The increased popularity of electric vehicles also is affected by batter technology that possess low energy density (short trip), high cost, and high risk of explosion or catching fire. In addition, the long charge times for current batteries in electric vehicles has made them impractical for mass adoption.

There are several deficiencies in battery systems in addressing these applications. Current commercial batteries aimed at grid scale applications tend to be extremely toxic and expensive. They usually operate at high temperatures and are not practical for other applications such as mobile or transportation. They are also prone to runaway reaction such as those occurring in lithium based batteries. Current battery technology cycle is also too low to be deemed practical for these applications. This makes true life time cost much higher than initial cost. Additionally, battery manufacturing is a complex and energy hungry process. This process may require complex and expensive machines and equipment that add to the overall cost and makes current battery technology expensive and thus impractical for cost sensitive applications. Therefore, a need exists for an improved battery with characteristics that are suitable to a wide range of applications such as electrical grid storage, renewable energy integration, and electric vehicle applications. A need also exists for a battery which employs a simplified manufacturing process that is overall inexpensive.

### SUMMARY OF THE INVENTION

In accordance with aspects of the present invention, there is provided an alkaline electrolyte comprising at least a synthesized molecular-mesh of starches infused with transition metal oxide nano-tubes. In particular the transition metal oxide may include titanium dioxide and the starches may include modified or reticulated starches. Batteries and electrochemical cells employing the electrolyte are also described. A method of synthesizing transition metal oxide nano-tubes is also described. Methods of making positive and negative nano-composite based active materials are described, as are electrochemical energy storage devices including the positive and negative nano-composite based active materials.

To this end, in an exemplary embodiment of the present invention, an alkaline electrolyte comprising at least a synthesized molecular-mesh of starches infused with transition metal oxide nano-tubes.

In an exemplary embodiment, wherein the starches comprise modified or reticulated starches.

In an exemplary embodiment, wherein the transition metal oxide comprises titanium dioxide.

In an exemplary embodiment, wherein each titanium dioxide nano-tube comprises a one dimensional nano-tube with a tubular structure diameter of approximately 7 nm to approximately 11 nm.

In an exemplary embodiment, wherein the alkaline electrolyte comprises an aqueous alkaline gel electrolyte.

In an exemplary embodiment of the present invention, an alkaline battery comprising: at least one anode; at least one cathode; and an alkaline electrolyte comprising a synthesized molecular mesh of starches infused with transition metal oxide nano-tubes; wherein the alkaline electrolyte separates the at least one anode from the at least one cathode.

In an exemplary embodiment, wherein the starches comprise modified or reticulated starches.

In an exemplary embodiment, wherein the transition metal oxide comprises titanium dioxide.

In an exemplary embodiment, comprising: at least one anode current collector connected to the at least one anode; and at least one cathode current collector connected to the at least one cathode; wherein the at least one anode current collector and the at least one cathode current collector are at least partly immersed in the alkaline electrolyte, the alkaline electrolyte separating the at least one anode current collector from the at least one cathode current collector.

In an exemplary embodiment, wherein: the at least one anode comprises at least a first anode and a second anode, and the at least one cathode comprises at least a first cathode and a second cathode; the first cathode and the second cathode are connected to opposing sides of the at least one cathode current collector; and each of the first anode and second anode are connected to respective ones of the at least one anode current collector.

In an exemplary embodiment, wherein the alkaline electrolyte comprises an aqueous alkaline gel electrolyte.

In an exemplary embodiment of the present invention, an alkaline battery comprising: an anode; a cathode; and a separator material comprising a front side and a rear side, each of the front and rear sides coated with an alkaline electrolyte comprising a synthesized molecular mesh of starches infused with transition metal oxide nano-tubes; wherein the anode contacts the front side of the coated separator material and the cathode contacts the rear side of the coated separator material, the coated separator material separating the anode from the cathode.

In an exemplary embodiment, wherein the starches comprise modified or reticulated starches

In an exemplary embodiment, wherein the transition metal oxide comprises titanium dioxide.

In an exemplary embodiment, wherein the separator material comprises at least one paper sheet.

To this end, in an exemplary embodiment of the present invention, a method of separating at least one anode and at least one cathode of an alkaline battery comprising: at least partly immersing the at least one anode and the at least one cathode in an alkaline electrolyte comprising a synthesized molecular mesh of starches infused with transition metal oxide nano-tubes, the alkaline electrolyte separating the at least one anode from the at least one cathode.

In an exemplary embodiment, wherein the starches comprise modified or reticulated starches.

In an exemplary embodiment, wherein the transition metal oxide comprises titanium dioxide.

In an exemplary embodiment, wherein the alkaline battery comprises at least one anode current collector connected to the at least one anode and at least one cathode current collector connected to the at least one cathode, the immersing comprising: at least partly immersing the at least one anode current collector and the at least one cathode current collector in the aqueous gel electrolyte, the aqueous gel electrolyte separating the at least one anode current collector from the at least one cathode current collector.

In an exemplary embodiment, wherein the at least one anode comprises at least a first anode and a second anode, and the at least one cathode comprises at least a first cathode and a second cathode, wherein the method comprises: connecting the first cathode and the second cathode to opposing sides of the at least one cathode current collector; and connecting each of the first anode and second anode to respective ones of the at least one anode current collector.

In accordance with an aspect of the present invention, there is provided an alkaline electrolyte comprising at least a synthesized molecular-mesh of starches infused with transition metal oxide nano-tubes. In accordance with an aspect of the present invention, there is provided the alkaline electrolyte wherein the starches comprise modified or reticulated starches. In accordance with an aspect of the present invention, there is provided the alkaline electrolyte wherein the transition metal oxide comprises titanium dioxide. In accordance with an aspect of the present invention, there is provided the alkaline electrolyte wherein each titanium dioxide nano-tube comprises a one dimensional nano-tube with a tubular structure diameter of approximately 7 nm to approximately 11 nm. In accordance with an aspect of the present invention, there is provided the alkaline electrolyte wherein the alkaline electrolyte comprises an aqueous alkaline gel electrolyte.

In accordance with an aspect of the present invention, there is provided an alkaline battery comprising: at least one anode; at least one cathode; and an alkaline electrolyte comprising a synthesized molecular mesh of starches infused with transition metal oxide nano-tubes; wherein the alkaline electrolyte separates the at least one anode from the at least one cathode. In accordance with an aspect of the present invention, there is provided the alkaline battery wherein the starches comprise modified or reticulated starches. In accordance with an aspect of the present invention, there is provided the alkaline battery wherein the transition metal oxide comprises titanium dioxide. In accordance with an aspect of the present invention, there is provided the alkaline battery comprising: at least one anode current collector connected to the at least one anode; and at least one cathode current collector connected to the at least one cathode; wherein the at least one anode current collector and the at least one cathode current collector are at least partly immersed in the alkaline electrolyte, the alkaline electrolyte separating the at least one anode current collector from the at least one cathode current collector. In accordance with an aspect of the present invention, there is provided the alkaline battery wherein: the at least one anode comprises at least a first anode and a second anode, and the at least one cathode comprises at least a first cathode and a second cathode; the first cathode and the second cathode are connected to opposing sides of the at least one cathode current collector; and each of the first anode and second anode are connected to respective ones of the at least one anode current collector. In accordance with an aspect of the present invention, there is provided the alkaline battery wherein the alkaline electrolyte comprises an aqueous alkaline gel electrolyte.

In accordance with an aspect of the present invention, there is provided an alkaline battery comprising: an anode; a cathode; and a separator material comprising a front side and a rear side, each of the front and rear sides coated with an alkaline electrolyte comprising a synthesized molecular mesh of starches infused with transition metal oxide nano-tubes; wherein the anode contacts the front side of the coated separator material and the cathode contacts the rear side of the coated separator material, the coated separator material separating the anode from the cathode. In accordance with an aspect of the present invention, there is provided the alkaline battery wherein the separator material comprises at least one paper sheet.

In accordance with an aspect of the present invention, there is provided a method of separating at least one anode and at least one cathode of an alkaline battery comprising: at least partly immersing the at least one anode and the at least one cathode in an alkaline electrolyte comprising a synthesized molecular mesh of starches infused with transition metal oxide nano-tubes, the alkaline electrolyte separating the at least one anode from the at least one cathode. In accordance with an aspect of the present invention, there is provided the method wherein the alkaline battery comprises at least one anode current collector connected to the at least one anode and at least one cathode current collector connected to the at least one cathode, the immersing comprising: at least partly immersing the at least one anode current collector and the at least one cathode current collector in the aqueous gel electrolyte, the aqueous gel electrolyte separating the at least one anode current collector from the at least one cathode current collector. In accordance with an aspect of the present invention, there is provided the method wherein the at least one anode comprises at least a first anode and a second anode, and the at least one cathode comprises at least a first cathode and a second cathode, wherein the method comprises: connecting the first cathode and the second cathode to opposing sides of the at least one cathode current collector; and connecting each of the first anode and second anode to respective ones of the at least one anode current collector.

In accordance with an aspect of the present invention, there is provided a method of separating an anode and a cathode of an alkaline battery comprising: coating front and rear sides of a separator material with an alkaline electrolyte comprising a synthesized molecular mesh of starches infused with transition metal oxide nano-tubes; contacting the anode to the front side of the coated separator material; and contacting the cathode to the rear side of the coated separator material; wherein the coated separator material separates the anode from the cathode.

In accordance with an aspect of the present invention, there is provided a method of synthesizing transition metal oxide nano-tubes comprising: mixing transition metal oxide with an aqueous solution of an alkaline electrolyte to produce a mixture; heating the mixture; washing the heated mixture; storing the washed mixture in a hydrochloric acid solution for a first time period; and drying the washed mixture for a second time period. In accordance with an aspect of the present invention, there is provided the method wherein the alkaline electrolyte comprises an aqueous solution of potassium hydroxide and water. In accordance with an aspect of the present invention, there is provided the method wherein the heating comprises heating the mixture with microwaves. In accordance with an aspect of the present invention, there is provided the method wherein the washing comprises washing the heated mixture with deionized distilled water.

In accordance with an aspect of the present invention, there is provided a method of preparing an alkaline electrolyte comprising: mixing an aqueous solution of an alkaline electrolyte with starch in an enclosed mixer; mixing transition metal oxide nano-tube powder into the mixture; and heating the mixture. In accordance with an aspect of the present invention, there is provided the method wherein the transition metal oxide comprises titanium dioxide. In accordance with an aspect of the present invention, there is provided the method wherein the alkaline electrolyte comprises an aqueous solution of potassium hydroxide and water. In accordance with an aspect of the present invention, there is provided the method wherein the heating comprises heating the mixture with microwaves. In accordance with an aspect of the present invention, there is provided the method comprising cooling the heated mixture in a sealed container. In accordance with an aspect of the present invention, there is provided the method wherein the sealed container comprises a vacuum container. In accordance with an aspect of the present invention, there is provided the method wherein the starch comprises corn starch. In accordance with an aspect of the present invention, there is provided the method comprising producing the transition metal oxide nano-tube powder at least partly by: mixing transition metal oxide with an aqueous solution of an alkaline electrolyte to produce a second mixture; heating the second mixture; washing the heated second mixture; storing the washed second mixture in a hydrochloric acid solution for a first time period; and drying the washed mixture for a second time period to produce the transition metal oxide nano-tube powder. In accordance with an aspect of the present invention, there is provided the method comprising varying a viscosity of the alkaline electrolyte at least partly by modifying a heating temperature and a heating duration during the heating step. In accordance with an aspect of the present invention, there is provided the method comprising varying an alkalinity of the alkaline electrolyte at least partly by modifying a ratio of the potassium hydroxide to the water in the aqueous solution. In accordance with an aspect of the present invention, there is provided the method comprising varying a viscosity of the alkaline electrolyte at least partly by modifying a ratio of starch to water in the aqueous solution mixed with starch. In accordance with an aspect of the present invention, there is provided the method comprising varying an ionic conductivity of the alkaline electrolyte at least partly by modifying a ratio of potassium hydroxide to transition metal oxide nano-tube powder in the aqueous solution mixed with starch and transition metal oxide. In accordance with an aspect of the present invention, there is provided the method comprising varying resistivity of the alkaline electrolyte at least partly by modifying a ratio of transition metal oxide to water in the aqueous solution mixed with starch and transition metal oxide.

In accordance with an aspect of the present invention, there is provided an electrochemical energy storage device comprising: at least one enclosure; at least one energy storage cell housed in at least one of the at least one enclosure, each of the at least one energy storage cell comprising: a positive electrode comprising positive nano-composite based active material; a negative electrode comprising negative nano-composite based active material; and a separator comprising at least one alkaline electrolyte; wherein the separator electrically separates the positive electrode from the negative electrode in the at least one enclosure. In accordance with an aspect of the present invention, there is provided the electrochemical energy storage device wherein the positive nano-composite based active material comprises a positive nano-composite based active ink and the negative nano-composite based active material comprises a negative nano-composite based active ink. In accordance with an aspect of the present invention, there is provided the electrochemical energy storage device wherein the separator comprises a substrate at least partly coated in the at least one alkaline electrolyte. In accordance with an aspect of the present invention, there is provided the electrochemical energy storage device wherein the separator comprises a substrate at least partly immersed in the at least one alkaline electrolyte. In accordance with an aspect of the present invention, there is provided the electrochemical energy storage device wherein the alkaline electrolyte comprises a synthesized molecular-mesh of modified or reticulated starches infused with transition metal oxide nano-tubes. In accordance with an aspect of the present invention, there is provided the electrochemical energy storage device wherein the transition metal oxide comprises titanium dioxide. In accordance with an aspect of the present invention, there is provided the electrochemical energy storage device chargeable at at least a first voltage range and a second voltage range. In accordance with an aspect of the present invention, there is provided the electrochemical energy storage device chargeable through application of a first voltage to the at least one energy storage cell, wherein the at least one energy storage cell achieves a first stored voltage dropping to a nominal voltage with no load. In accordance with an aspect of the present invention, there is provided the electrochemical energy storage device chargeable through application of a second voltage to the at least one energy storage cell, wherein the at least one energy storage cell achieves a second stored voltage, the second voltage being less than the first voltage, the second stored voltage being less than the first stored voltage.

In accordance with an aspect of the present invention, there is provided a method comprising: mixing transition metal oxide nano-tubes with ethanol and at least one metal powder to produce a first mixture; heating the first mixture; washing the heated first mixture; adding at least one alkaline electrolyte to the washed first mixture and heating to produce a second mixture; and extracting precipitate from the second mixture to produce a nano-composite based active material. In accordance with an aspect of the present invention, there is provided the method wherein the metal powder comprises a fine metal powder. In accordance with an aspect of the present invention, there is provided the method wherein the metal powder comprises copper oxide, and the produced nano-composite based active material comprises a positive nano-composite based active material. In accordance with an aspect of the present invention, there is provided the method wherein the metal powder comprises zinc oxide, and the produced nano-composite based active material comprises a negative nano-composite based active material. In accordance with an aspect of the present invention, there is provided the method comprising applying the nano-composite based active material to a substrate to produce at least one electrode. In accordance with an aspect of the present invention, there is provided the method wherein the applying comprises applying the nano-composite based active material onto the electrode using a printer device. In accordance with an aspect of the present invention, there is provided the method wherein the substrate comprises a separator material, and the electrode, subsequent to the applying, comprises a coated separator material. In accordance with an aspect of the present invention, there is provided the method comprising adding a solvent to the nano-composite based active material to produce a nano-composite based active ink. In accordance with an aspect of the present invention, there is provided the method comprising micro-fining the nano-composite based active material and wherein the applying comprises applying the nano-composite based active material onto the substrate using a laser printer device.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 is a flow chart illustrating a manufacturing process for highly ionic hybrid alkaline aqueous gel electrolyte (or “HAAGE”), according to the present disclosure;

FIG. 2 is a flow chart illustrating a method for preparing titanium dioxide nano-tubes in accordance with the present disclosure;

FIG. 3 is a table illustrating physical properties of a titanium dioxide nano-tube sample, according to the present disclosure;

FIG. 4 is a graph showing an XRD pattern for phase identification for titanium dioxide (anatase) synthesized in accordance with the present disclosure;

FIG. 5 is a scanning electron microscope image of a sample of synthesized titanium dioxide nano-tubes, in accordance with the present disclosure;

FIG. 6 illustrates an exemplary method for producing approximately about 1 liters of HAAGE, according to the present disclosure;

FIG. 7 shows a macro and an enlarged representation of a structure of HAAGE, according to the present disclosure;

FIG. 8 illustrates molecular structures of amylopectin and amylase in accordance with the present disclosure;

FIG. 9 is a graph illustrating values for measured conductivity of HAAGE over temperature, at a constant pressure of 30 Bar, according to the present disclosure;

FIG. 10 is a graph illustrating values for measured conductivity of HAAGE over temperature, at a constant pressure of 40 Bar, according to the present disclosure;

FIG. 11 shows photographs of samples of HAAGE prepared in accordance with the method of the present disclosure;

FIG. 12 is a plot of current-potential measured for a nano-synthetic battery employing aqueous KOH (35%) and a nano-synthetic battery employing HAAGE in accordance with the present disclosure;

FIG. 13 illustrates various exemplary uses of HAAGE in accordance with the present disclosure;

FIG. 14 is a perspective cutaway view of a typical single cell design comprising spiral wound electrodes, according to the present disclosure;

FIG. 15 is a table illustrating form factors for a nano-synthetic cell (NS) in accordance with the present disclosure;

FIG. 16 illustrates a stacked electrode configuration of a NS cell, according to the present disclosure;

FIG. 17 illustrates a foil construction of a NS cell which provides for very thin and lightweight cell designs suitable for high power applications, according to the present disclosure;

FIG. 18 illustrates a NS cell configured as a prismatic cell contained in a rectangular can, according to the present disclosure;

FIG. 19 illustrates an exemplary method whereby nano-particles are converted into an ink by mixing with a solvent, in accordance with the present disclosure;

FIG. 20 is a table illustrated methods of processing combinations to create unique nano-based active inks, according to the present disclosure;

FIG. 21 is a flow chart illustrating a method for preparing a positive nano-composite active material, according to the present disclosure;

FIG. 22 is a flow chart illustrating a method for preparing a positive nano-composite active material in accordance with the present disclosure;

FIG. 23 is a flow chart illustrating a method for preparing a negative nano-composite active material, according to the present disclosure;

FIG. 24 in a graph illustrating methods for coating an electrode using a nano-synthetic ink created in accordance with the present disclosure;

FIG. 25 illustrates various exemplary uses of HAAGE in accordance with the present disclosure;

FIG. 26 comprises photos of an exemplary embodiment of a positive nano-composite active ink, according to the present disclosure;

FIG. 27 comprises photos of an exemplary embodiment of a negative nano-composite active ink in accordance with the present disclosure;

FIG. 28 is a photo of a HAAGE electrolyte after synthesis in accordance with the present disclosure;

FIG. 29 is a photo of a HAAGE electrolyte coating a separator sheet in accordance with the present disclosure;

FIG. 30 is a photo of a nano-synthetic prototype single cell enclosure in accordance with the present disclosure;

FIG. 31 is a graph illustrating CuO/TiO₂ Nano-composite vs. ZnO/TiO₂ Nano-composite-HAAGE and CuO/TiO₂ Nano-composite vs. ZnO/TiO₂ Nano-composite-KOH 35% in accordance with the present disclosure;

FIG. 32 is a graph illustrating Cu₂O/TiO₂ Nano-composite vs. ZnO/TiO₂ Nano-composite-HAAGE and Cu₂O/TiO₂ Nano-composite vs. ZnO/TiO₂ Nano-composite-KOH 35%, according to the present disclosure;

FIG. 33 is a graph illustrating CuO/TiO₂ Nano-composite vs. Zn/TiO₂ NT-HAAGE and CuO/TiO₂ Nano-composite vs. Zn/TiO₂ NT-KOH 35%, according to the present disclosure; and

FIG. 34 is a graph illustrating Cu₂O/TiO₂ Nano-composite vs. Zn/TiO₂ NT-HAAGE and Cu₂O/TiO₂ Nano-composite vs. Zn/TiO₂ NT-KOH 35% in accordance with the present disclosure.

### DETAILED DESCRIPTION

Before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting. For example, even any specific words in this description suggesting that a characteristic, property, element, feature, or any other aspect of the present invention is to be limited in any way are not intended to so limit the scope of the invention. For example, words such as “must be”, “should be”, “required”, or the like, are not intended to limit the scope of the invention, but rather provide disclosure of aspects of the present invention,

This invention describes an electrically rechargeable battery. This invention also describes materials which may be used in the battery of the present invention, and methods of making both the materials and the battery.

### Hybrid Alkaline Aqueous Gel Electrolyte

An electrolyte is a material that may be used in a battery to conduct electricity, particularly between cathode and anode components in contact with the electrolyte. Typically, an electrolyte is a highly ionic gel that allows charged ions to move between positive and negative electrodes of a primary/secondary cell in a battery. In accordance with an aspect of the present invention, a highly ionic hybrid alkaline aqueous gel electrolyte (or “HAAGE”) is presented. HAAGE may be used as both an electrolyte and a physical separator for alkaline batteries and devices. HAAGE is an alkaline electrolyte which may use potassium hydroxide in its creation. HAAGE may comprise a gel that is derived from modified or reticulated starches. Although the electrolyte of the present invention will be primarily discussed in terms of a water-based gel form, the electrolyte may also be made into a liquid, solid, or other gel.

HAAGE may be well-suited for use in both primary and secondary electrochemical devices such as metal/air, Zn/MnO₂, Ni/Cd and hydrogen fuel cells. Furthermore, in rechargeable electrochemical cells, HAAGE may be effective for use as a combination electrolyte/separator between the anode and cathode. In accordance with aspects of the present invention, the highly ionic HAAGE is comprised of a synthesized molecular-mesh of modified or reticulated starches infused with transition metal oxide nano-tubes, such as titanium dioxide (TiO₂) nano-tubes.

By providing the multiple functions of a separator and electrolyte in one, cost may be reduced over existing electrolytes. HAAGE is also highly ionic (e.g. 0.49 S/cm to 0.61 S/cm). HAAGE is also made from mainly food-based materials, so it is inherently non-toxic to humans and the environment. HAAGE may provide improved mechanical strength over a wide temperature range compared to existing electrolytes. HAAGE may also suppress dendrite growth during charge/discharge cycles and may reduce expansion and swelling during charge/discharge of secondary cells. HAAGE may facilitate ‘trapping’ or ‘buffering’ and absorption of hydrogen to improve burst mode performance of nano-synthetic cells and may improve overall power output, and power density of nano-synthetic cells, and may provide an improved extended mode performance of a non-synthetic cell, described later herein.

HAAGE may be made from materials including: corn starch (food grade), 100% purity; potassium hydroxide solids (flakes or pellets), at least 99.9% purity; TiO₂ nano-tubes (anatase). The TiO₂ nano-tubes may be produced by known methods such as hydrothermal synthesis, anodization, or microwave assisted liquid synthesis, and in particular as described herein.

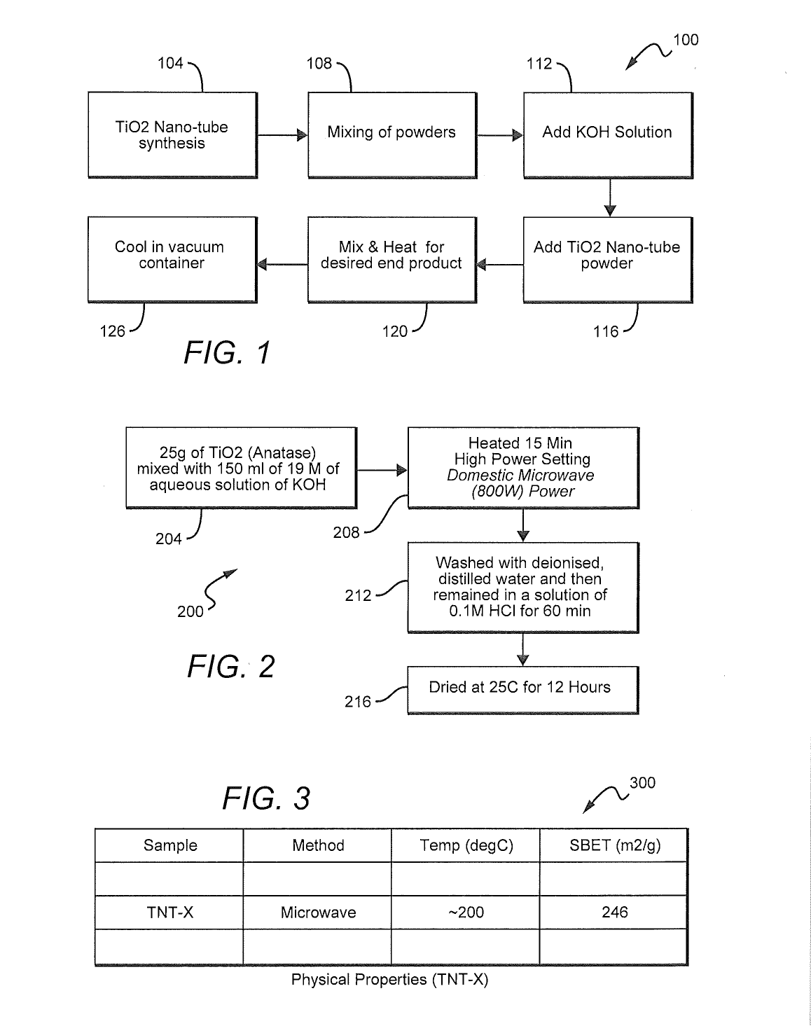

A HAAGE manufacturing process flow 100 is shown in FIG. 1. First, the TiO₂ nano-tubes are synthesized, or otherwise acquired in step 104. The corn starch is mixed in step 108 and the KOH solution is added in step 112. The TiO₂ nano-tubes are added to that, in step 116, and mixed and heated for a desired end product in step 120, then cooled in a container, such as a sealed container or vacuum sealed container in step 124.

Although HAAGE is described herein as using TiO₂ in its preparation, other transition metal oxides may be used as well, in the place of, or in addition to TiO₂, including, for example, ZnO, and CuO.

### Titanium Dioxide Nano-Tube Preparation Method

In accordance with an aspect of the present invention, a method of preparing titanium dioxide nano-tubes is provided. While microwave irradiation is described, other methods of heating the titanate are possible. Microwave irradiation is an efficient and distinct heating method due to very short reaction time and low energy consumption needed for the reactions. compared with other methods, microwave-assisted preparation of one-dimensional nanostructures of TiO₂ using KOH aqueous and TiO₂ anatase powder is fast and effective. This method utilizes minimum reagents and produces relatively pure materials. The nano-tube products were highly pure yield >90% having a length up to 6 to 10 micrometers and having an open end diameter of about 6 to 9 nm.

In accordance with an aspect of the present invention, a method for preparing titanium dioxide nano-tubes 200 is provided, with reference to FIG. 2. The method includes mixing TiO₂ with an aqueous solution of KOH in step 204. Mixing with other alkaline electrolytes may also be possible. In this example, 25 g of TiO2 is mixed with 150 ml of 19 M of KOH and heated for 15 minutes at a high power setting of a 800 W microwave in step 208. Other durations, power settings, and microwaves may also be used. The resulting heated mixture is then washed in step 212, for example with de-ionized distilled water and then stored in a solution of 0.1M HCl (or hydrochloric acid) for about 60 minutes. The resulting material may then be dried in step 216, for example at 25 degrees C. for 12 hours.

Samples of titanium dioxide nano-tubes created using this method, which may be referred to as TNT-X, were examined. Findings included that the samples were composed of tubular structures with a diameter range of about 7 nm to about 11 nm. The presence of K+ ions in the TNT-X sample could lead to increased surface charge and electrostatic attraction of individual tubes. The physical properties of the TNT-X sample are shown in a table 300 illustrated in FIG. 3 and included SBET of 246 m²/g

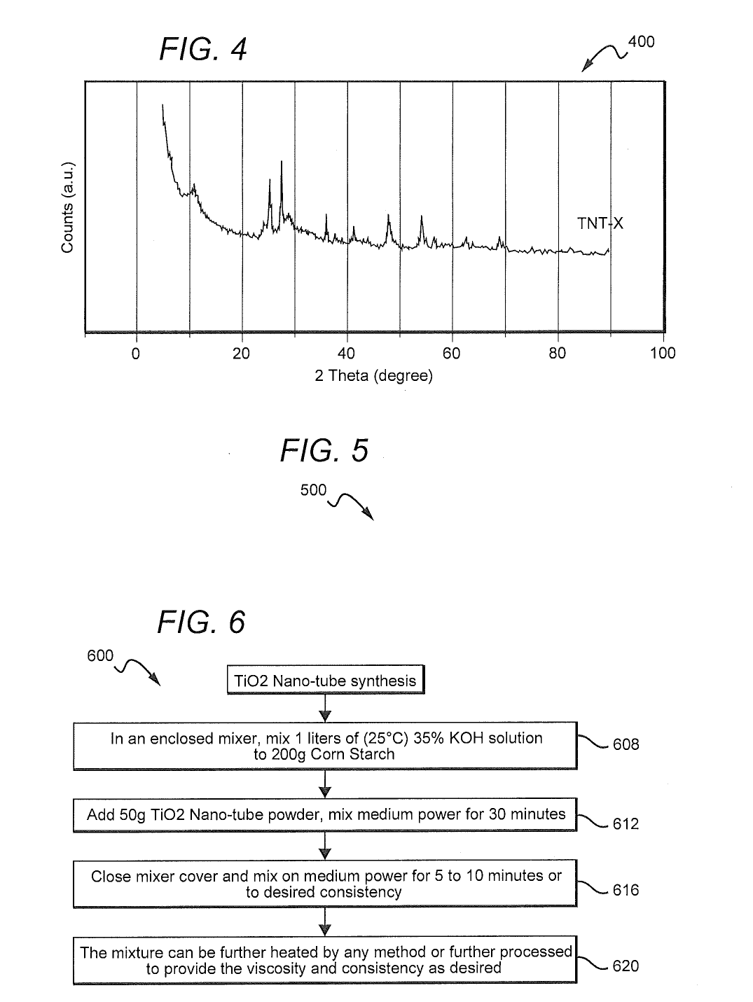

FIG. 4 is a graph 400 showing an XRD pattern for phase identification for titanium dioxide (anatase) synthesized in accordance with the present invention. The XRD patterns shown were measured on powdered samples with a Phillips X′Pert MR diffractometer using secondary graphite monochromated Cu K radiation (=1.542 Å@40 kV/50 mA).

FIG. 5 shows a scanning electron microscope image 500 of a sample of the synthesized titanium dioxide nano-tubes synthesized in accordance with the present invention. The SEM measurements were carried out in a Leo, Zeiss FE-SEM microscopy, 2 kV EPD.

### HAAGE Preparation Method

In accordance with an aspect of the present invention, a method 600 of preparing HAAGE is provided. An exemplary implementation of the method 600 for producing approximately about 1 liters of HAAGE is shown in FIG. 6. In an enclosed mixer, 1 liter of 25 degrees celsius 35% KOH solution is mixed with 200 g of corn starch at medium mixing power for approximately 15 minutes in step 608. In a step 612, 50 g of TiO₂ nano-tube powder is then added to the mixture and mixed at medium power for approximately 30 minutes. The titanium dioxide may be synthesized in accordance with the method described herein, or alternative methods of synthesizing or sourcing the titanium dioxide may be employed. Optionally, the mixer is covered and mixed again on medium power for 5 to 10 minutes or to a desired consistency in step 616. The mixture can be further heated by any method or further processed to provide viscosity and/or consistency as desired in a step 620.

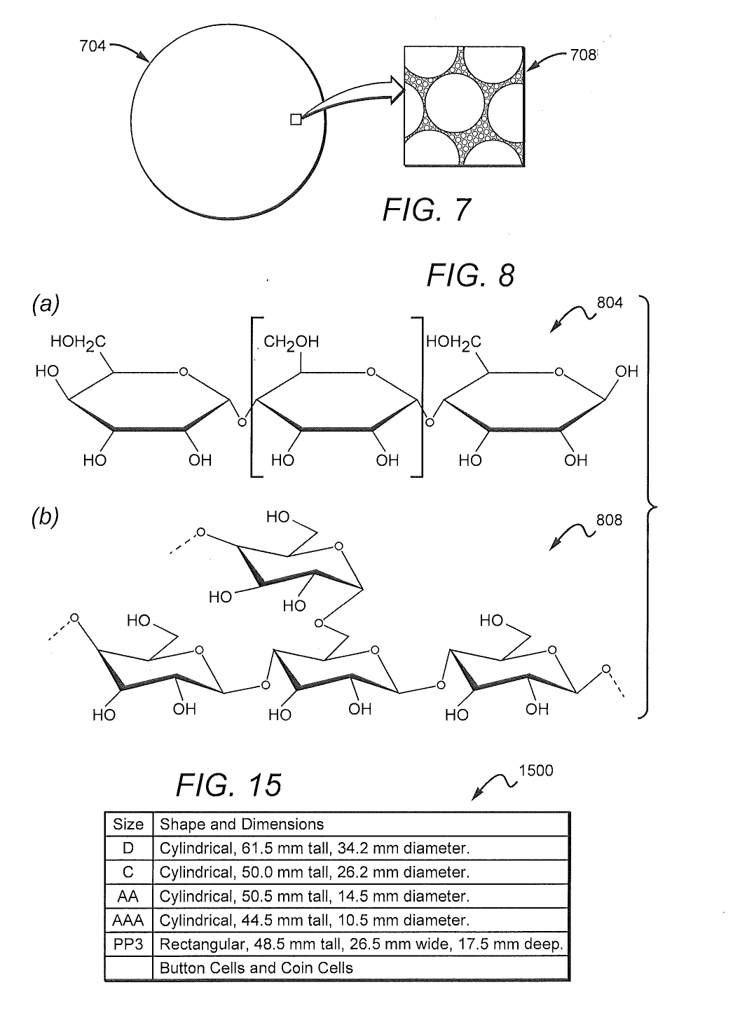

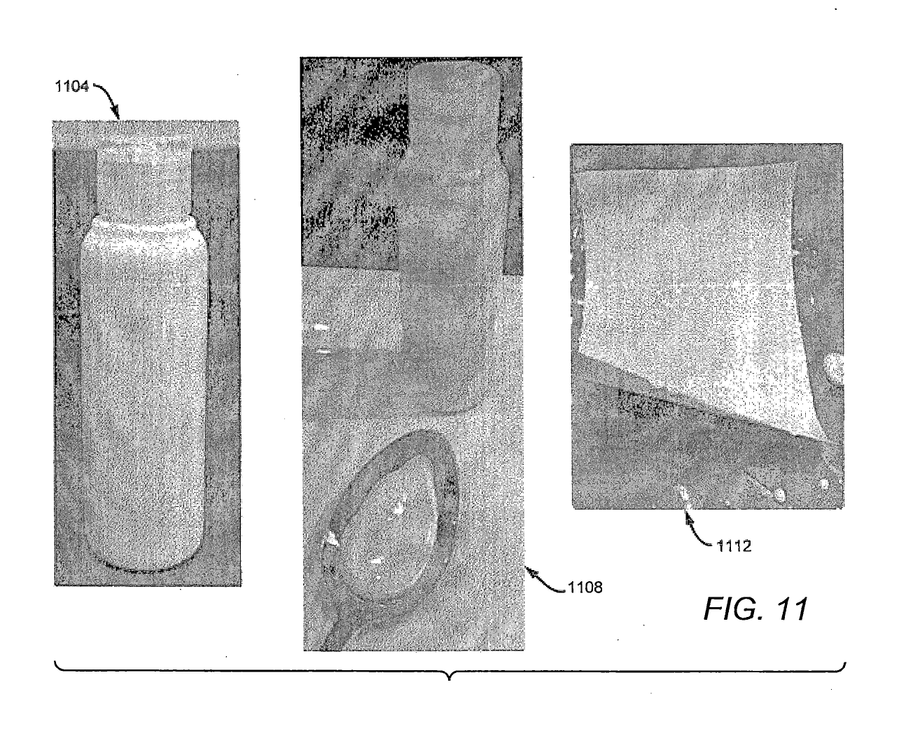

After the gelling process is complete, TiO₂ nano-tubes are embedded in the alkaline aqueous gel electrolyte where it remains. HAAGE is highly ionic and behaves like a liquid electrolyte, while at the same time, the reticulated starches species infused with TiO₂ nano-tubes provides a smooth impenetrable surface that allows for the exchange of ions while providing protection to both the positive and negative electrode. FIG. 7 shows a macro and enlarged representation of the structure of HAAGE, 704 and 708, respectively, showing glucose molecules and TiO₂ nano-tubes. FIG. 11 shows photographs 1104, 1108, and 1112 of samples of HAAGE prepared in accordance with the method of the present invention.

Changing the ratios of materials used in the HAAGE preparation method may provide for variations in the desired qualities of the resulting HAAGE. For example, variations may include: varying a ratio of KOH to H₂O to determine the alkalinity of the final product; varying a ratio of corn starch to H₂O to determine the viscosity of the final product; varying a ratio of KOH to TiO₂ nano-tubes to determine the ionic conductivity of the final product; and varying a ratio of TiO₂ to H₂O to determine the conductivity or resistivity of the final product (separator qualities).

Corn starch is made up of many molecules of glucose, specifically amylopectin 808 and amylase 804. The molecular structures of amylopectin 808 and amylase 804 are shown in FIG. 8. In this process food grade starches are used to create HAAGE with very high ionic properties. The infusion of TiO₂ nano-tubes with specific morphologies and physical characteristics into the gel may result in a unique active separator-like property that inhibits the growth of dendrites between positive and negative electrode. When the heated mixture cools down, the TiO₂ nano-tubes dispersed with amylase molecules 804 bind to each other creating a molecular mesh. Generally, the more amylase molecules 804 there are, the firmer, or more viscous, the mesh will be.

While this preparation method describes the use of corn starch, other starches may be used, including, but not necessarily limited to potato starch, wheat starch, and rice starch. Different end products can be made using different starches because starch consistencies vary with the proportions of amylase and amylopectin that comprise them.

The TiO₂ nano-tubes may add mechanical strength during the expansion-contraction phases of secondary cell charging/discharging when HAAGE is employed as an electrolyte in a battery cell. The TiO₂ Nano-tubes fill gaps in-between the amylase and amylopectin molecules creating a thin, impenetrable surface that retard dendrite growth. This thin mesh may also act like a physical separator in an electrochemical cell and device thereof that require a physical separator that allows high ionic conductivities to create charge differentials.

HAAGE made as described herein may have properties including being pasty or sticky, which may allow for good bonding with a battery or storage device's active material onto electrically conductive surfaces such as electrodes. This stickiness allows or helps to “hold” active materials in place while allowing for high ionic conductivities (charged ions to pass through).

Using this technique, various materials of different shapes, sizes, thickness/thinness, conductivity/resistivity and viscosity can be created. Various variations can be created by manipulating the ratio of each materials.

The combination of TiO₂ nano-tubes, amylase, and amylopectin structures trap and retain hydrogen for short periods of time (e.g. milliseconds). This behavior may contribute to increased current or increased power output of a battery or electrochemical cell using the HAAGE electrolyte. The absorbed hydrogen creates an electron space charge layer on the walls of the nano-tubes (tube to tube contact regions). A typical nano-synthetic cell of the present invention using HAAGE was successfully operated between −65 degrees Celsius and 120 degrees Celsius.

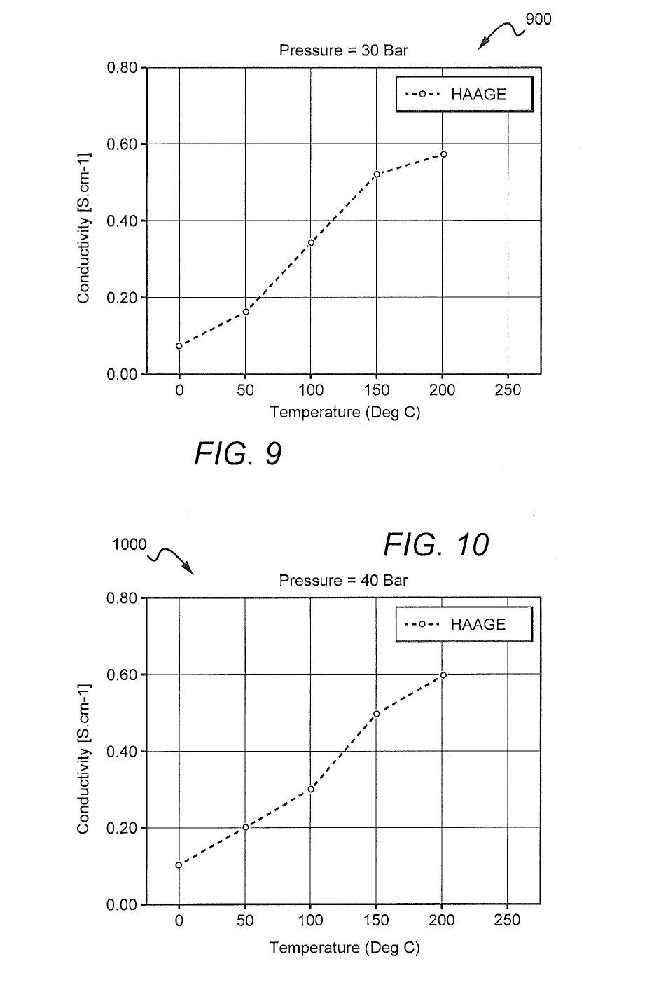

It is important to know the conductivity of the HAAGE electrolyte at a given temperature and concentration to reduce the polarization loss and provide for optimization of cell and system design. The conductivity of HAAGE at various temperatures and concentrations was investigated using the Vander Pauw method in combination with electrochemical impedance spectroscopy (EIS). The values for the measured conductivity of HAAGE over temperature (prepared via the method described herein) at a constant pressure of 30 Bar are shown in a graph 900 illustrated in FIG. 9. Values for the measured conductivity of HAAGE over temperature at a constant pressure of 40 Bar are shown in a graph 1000 illustrated in FIG. 10.

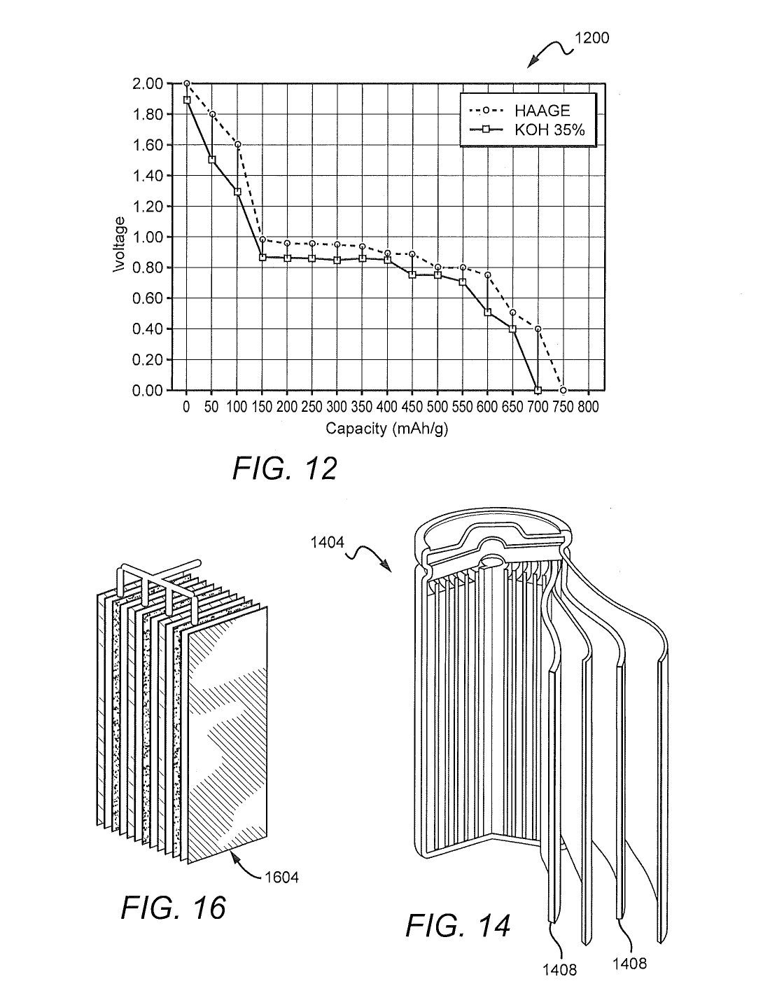

FIG. 12 shows a plot 1200 of current-potential measured for a nano-synthetic battery employing aqueous KOH (35%) and a nano-synthetic battery employing HAAGE made in accordance with the present invention. In this test, the HAAGE electrolyte demonstrates improved performance over the KOH electrolyte. This improved performance may be as a result of HAAGE holding the active material in place thereby allowing for more or all the active materials to react.

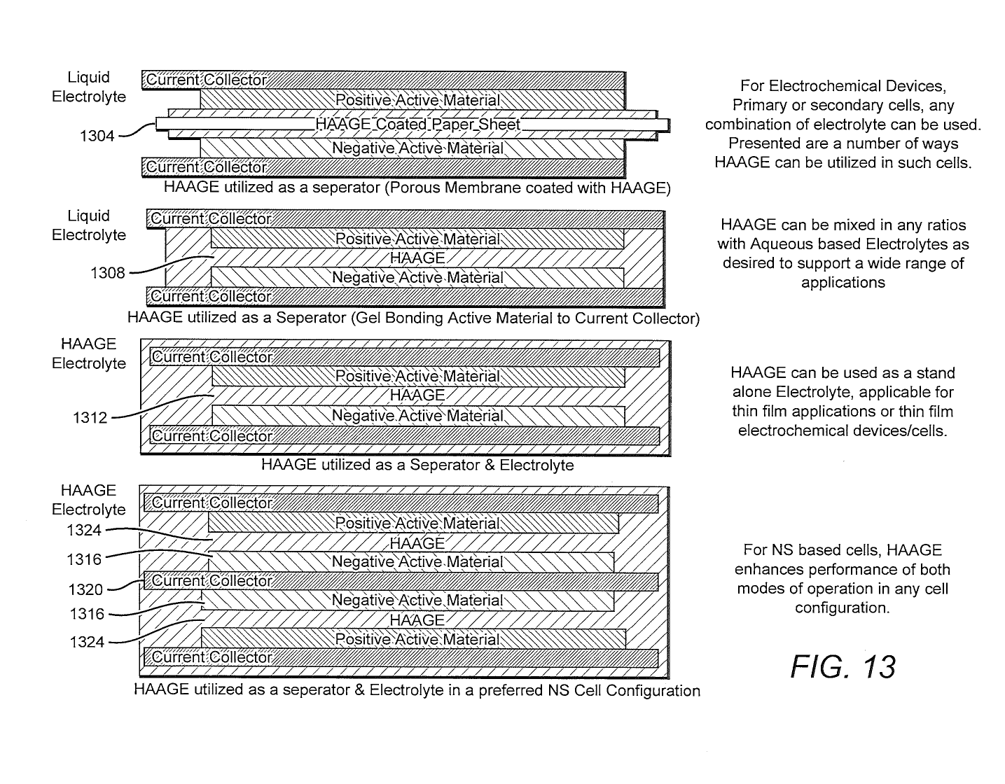

Various usages for HAAGE are possible, as shown in FIG. 13. For example, for electrochemical devices, many combinations of electrolytes may be used. FIG. 13 shows several non-limiting exemplary ways in which HAAGE may be used in such cells. For example, HAAGE may be utilized as a separator such as a porous membrane coated with HAAGE 1304. The membrane may comprise a substrate or a separator material, such as paper, fiber glass, or any other porous or non-porous separator. HAAGE may be used as the entire separator, for example, as a gel bonding active material 1308 to current collectors in the cell. HAAGE may be utilized as both a separator and electrolyte 1312 where all or part of the current collector is at least partly immersed or coated in HAAGE. A nano-synthetic cell configuration may also include negative active material 1316 contacting sides of a current collector 1320, each negative active material 1316 separated from positive active material by HAAGE 1324. Each positive active material may be contacting a respective current collector, as shown in FIG. 13. HAAGE can be mixed in a variety of ratios with other electrolytes, such as alkaline electrolytes, such as aqueous based electrolytes, as desired to support a wide range of applications. HAAGE may also be used as a stand-alone electrolyte, which may be used in thin film applications or thin film electrochemical devices/cells. For nano-synthetic based cells, HAAGE may enhance performance of both modes of operation in any cell configuration.

### Nano-Composite Energy Storage System

A nano-synthetic (“NS”) cell is an electrochemical device that stores electrical energy. It is an alkaline rechargeable secondary cell, and may comprise an aqueous alkaline rechargeable secondary cell. Although the NS of the present invention may be described herein in an aqueous implementation, solid, liquid, and gel-based NS cells may be possible. A NS cell of the present invention may be made in a variety of shapes, sizes, and configurations, and may comprise a positive electrode separated with a separator from a negative electrode and immersed in an alkaline based electrolyte. The positive and negative electrodes are made of nano-composite active materials, such as, for example, in ink format. While the materials may be described as inks herein, other forms of the nano-composite active materials are also possible, including a powder form or other solid or liquid forms.

Components of a NS cell of the present invention may include: an electrode containing positive active material (e.g. active ink) (cathode); an electrode containing negative active material (e.g. active ink) (anode); a separator, such as any material that prohibits positive and negative electrodes from shorting while allowing for flow of ions/charge between both electrodes; an electrolyte, such as KOH, NAOH, LIOH, or HAAGE of the present invention as described herein (other alkaline gels or electrolytes, or combinations of more than one electrolyte may be used); and a physical enclosure which may be a water proof substrate such as plastic foil for thin film or any material that encases the NS cell or group of cells. A typical single cell configuration 1404 may comprise spiral wound electrodes 1408, also called jelly-roll or Swiss-roll construction, as shown in FIG. 14.

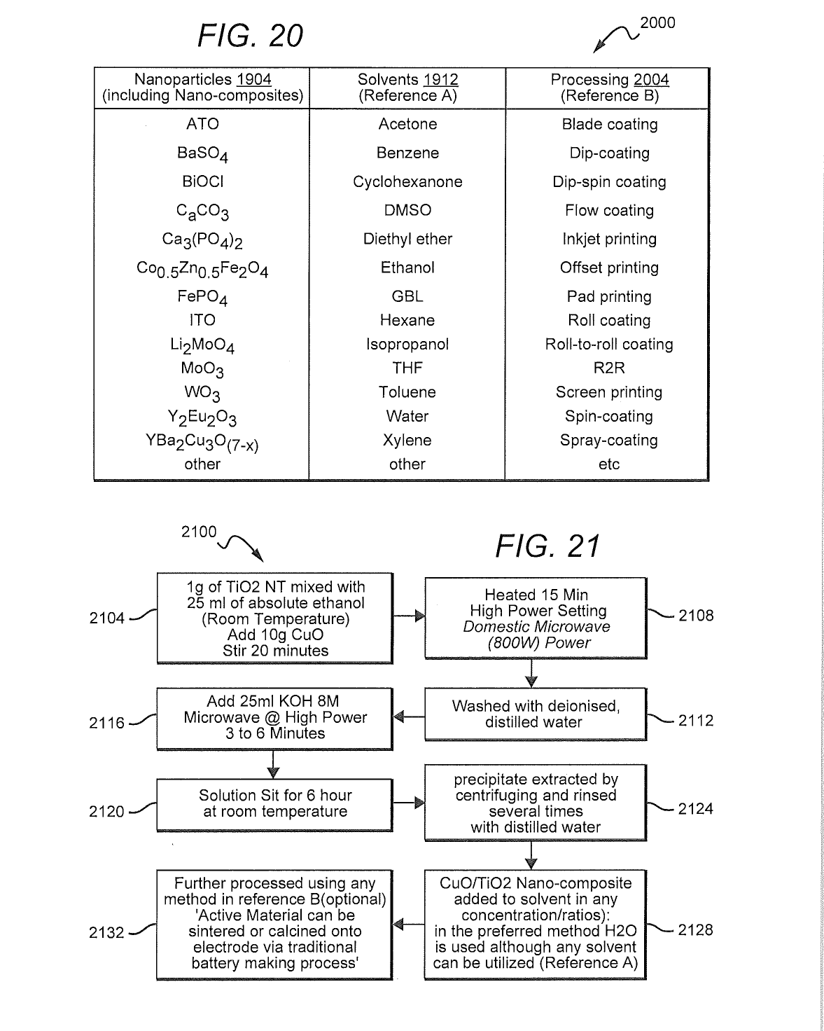

In accordance with aspects of the present invention, nano-particles 1904 may be converted into an ink 1908 by mixing with a solvent 1912 as shown in FIG. 19. Examples of nano-particles 1904 and solvents 1912 are listed in a table 2000 illustrated in FIG. 20, as are methods of processing 2004 combinations to create unique nano-based active inks 1908. For example, nano-particles may include: ATO; BaSO₄; BiOCl; CaCO₃; Ca₃(PO₄)₂; Co_{0.5}Zn_{0.5}Fe₂O₄; FePO₄; ITO; Li₂MoO₄; MoO₃; WO₃; Y₂Eu₂O₃; YBa₂Cu₃O₍₇₋ₓ₎; and others. For example, solvents 1916 may include: acetone; benzene; cyclohexanone; DMSO; diethyl ether; ethanol; GBL; hexane; isopropanol; THF; toluene; water; xylene; and others. For example, processing 2004 may include: blade coating; dip-coating; dip-spin coating; flow coating; inkjet printing; offset printing; pad printing; roll coating; roll-to-roll coating; R2R; screen printing; spin-coating; spray-coating; and others.

The basic composition of the NS cell includes: positive ink (nano-composite based active material); negative ink (nano-composite based active material); electrolyte (any alkaline aqueous/gel/solid). The core of the energy storage system includes the positive and negative inks.

### Method of Preparing Positive(Cathode) Nano-Composite Active Material

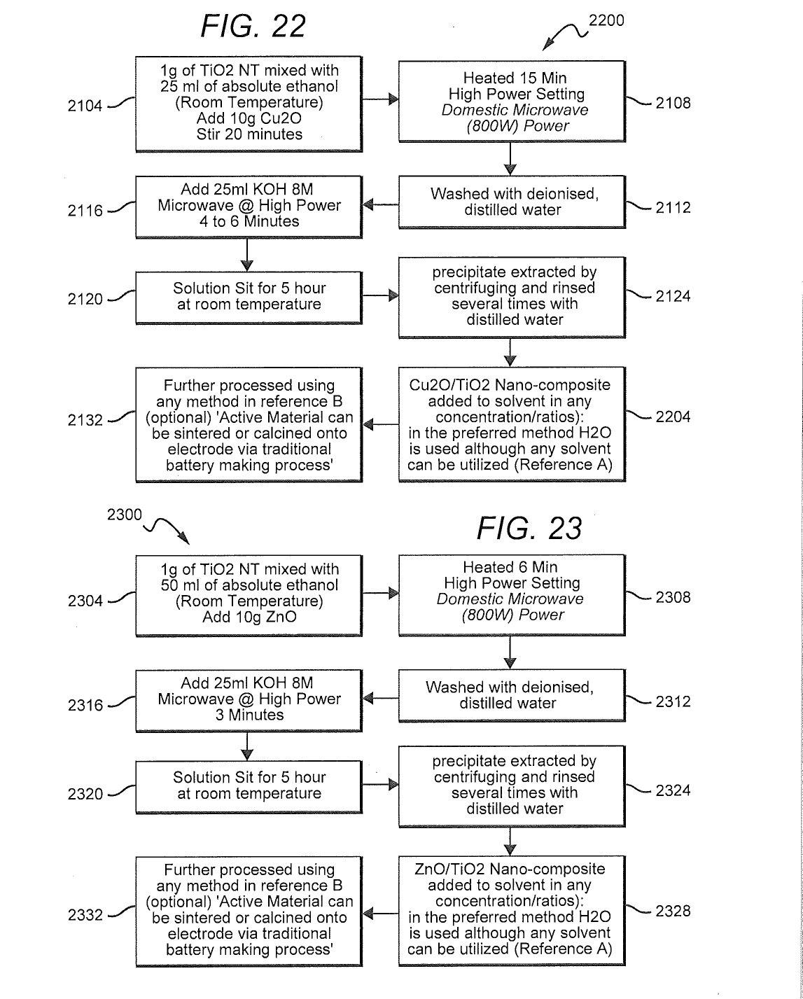

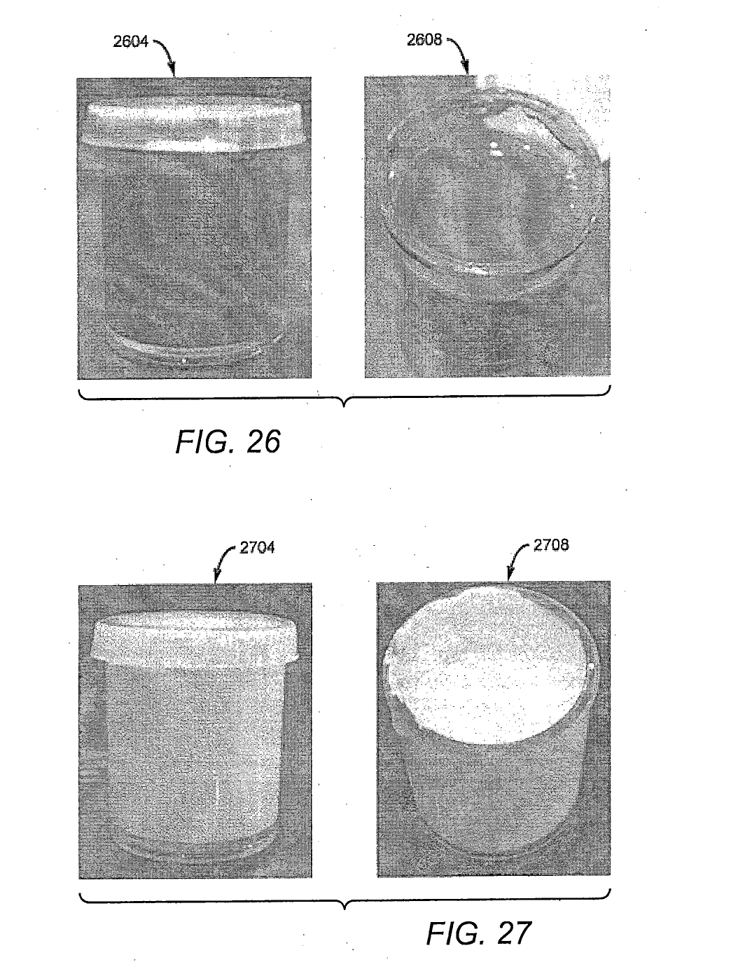

In accordance with an aspect of the present invention, materials used in the preparation of positive nano-composite active material may include: 100% ethanol; potassium hydroxide (99.9% purity), such as potassium hydroxide flakes; transition metal oxide nano-tubes, such as TiO₂ 1-dimensional Nano-tubes which may be prepared as described herein with reference to HAAGE; and a metal powder, such as micro-fined (or ball-milled) CuO (99.9% purity). In accordance with an aspect of the present invention, a method is provided for preparing the positive nano-composite active material, as shown in the non-limiting exemplary method 2100 of FIG. 21. In this example, in a step 2104 1 g of TiO₂ nano-tubes are mixed with 25 ml of absolute ethanol (at room temperature). 10 g of CuO is added and the mixture is stirred or mixed for 20 minutes. The mixture may then be heated for 15 minutes at a high power setting of a domestic microwave having 800 W power in step 2108. The heated mixture may then be washed, for example with deionized distilled water in a step 2112. In a step 2116, 25 ml of KOH 8M may be added, and then microwaved again at high power for 3 to 6 minutes. The solution may be left to sit for a period of time, such as, for example, 6 hours at room temperature in step 2120. Precipitate may be extracted by centrifuging and rinsing several times with distilled water in step 2124. Optionally, in order to produce an ink version of the nano-composite active material, a solvent may be used in step 2128. For example, the CuO/TiO₂ nano-composite material may be added to a solvent in any concentration/ratios desired. H₂O or any other solvent can be utilized, and in particular any solvent described above. Further processing may be performed using any processing method described above in step 2132. In a variation method 2200, shown in FIG. 22, Cu₂O may be used in place of CuO in a step 2204. Exemplary photos 2604 and 2608 of a positive nano-composite active ink resulting from this method are shown in FIG. 26.

### Method of Preparing Negative(Anode) Nano-Composite Active Material

In accordance with an aspect of the present invention, materials used in the preparation of positive nano-composite active material may include: 100% ethanol; potassium hydroxide (99.9% purity), such as potassium hydroxide flakes; transition metal oxide nano-tubes, such as TiO₂ 1-dimensional Nano-tubes which may be prepared as described herein with reference to HAAGE; and a metal powder, such as micro-fined ZnO (99.9% purity). Other metal powders which may be used may include any ultra-fine transition metal oxide powder or ultra-fine metal powder, or combinations thereof, including metal powders such as MgO, FeO, ZnO, Fe₂O₃, Fe₃O₄, ZN, FE, Ti, and others.

In accordance with an aspect of the present invention, a method 2300 is provided for preparing the negative nano-composite active material, as shown in the non-limiting exemplary method of FIG. 23. In this example, in a step 2304 1 g of TiO₂ nano-tubes are mixed with 50 ml of absolute ethanol (at room temperature). 10 g of ZnO is added and the mixture may be stirred or mixed for a period of time, such as 20 minutes. The mixture may then be heated for a period of time, such as 6 minutes, at a high power setting of a domestic microwave having 800 W power in step 2308. The heated mixture may then be washed, for example with deionized distilled water in step 2312. In a step 2316, 25 ml of KOH 8M may be added, and then microwaved again at high power for approximately 3 minutes. The solution may be left to sit for a period of time, such as, for example, 5 hours at room temperature in step 2320. Precipitate may be extracted by centrifuging and rinsing several times with distilled water in step 2324. The ZnO/TiO₂ nano-composite material may be added to a solvent in any concentration/ratios desired in step 2328. H₂O or any other solvent can be utilized, and in particular any solvent described above. Further processing may be performed using any processing method described above in step 2332.

Nano-composite active materials synthesized by the described methods can be dried and made into powdered form. The nano-composite active materials may then be made into inks, paste, solids, or other forms as desired by mixing or further processing with other chemicals or by other processes. The nano-composite active materials may then be applied by any method to a current collector, optionally for use in an electrochemical cell or other energy storage device.

Exemplary photos 2704 and 2708 of a negative nano-composite active ink resulting from this method are shown in FIG. 27.

### Method of Making Nano-Synthetic Electrode (Positive or Negative Electrode)

The preferred method of making a nano-synthetic cell electrode is by utilizing nano-synthetic inks created as described above; however, active material created formed as a paste, powder, or other form, may also be utilized. As such, any common or uncommon techniques can be used to administer the active material(s) onto the electrode or incorporate in the electrode.

The electrode (current carrying conductor) for a nano-synthetic cell can be made of any conductive material such as: iron, steel, nickel, copper, conductive graphite (any form), conductive plastics, etc. The electrode can be made in any shape, dimension, thickness, and by any method. Optionally, the electrode material for the nano-synthetic cell may be steel, thereby yielding about 6000 to 8000 full DOD cycles. Optionally, the electrode material for the nano-synthetic cell may be a conductive graphite sheet, thereby yielding about at least 20,000 full DOD cycles.

In accordance with an aspect of the present invention, a method of coating an electrode using a nano-synthetic ink created as per the process described herein, is provided. The active ink can be placed into industrial/commercial printers and printed either directly onto the electrode surface, or onto a material such as paper. The coated paper may then be sandwiched onto the electrode surface such that the active material makes contact with the electrode surface. The active material may be printed onto a substrate of any kind that will be used as an electrode. The coating process can utilize any method or technique. Optionally, one method may be printing. Other methods are shown in a table 2400 illustrated in FIG. 24 and may be used in combinations with one another. The methods may include: blade coating; dip-coating; dip-spin coating; flow coating; inkjet printing; offset printing; pad printing; roll coating; roll-to-roll coating; R2R; screen printing; spin-coating; spray-coating, etc. If the active material is further ball-milled or put through a process of micro-fining then a laser printing technique may be utilized. The active material can also be put into or mixed into/with a polymer or polymers and applied onto a conducting surface. Active materials can be sintered and or calcined as desired to create electrodes. Machines or equipment which may be used to facilitate the coating and depend upon the coating method employed. One method utilizes industrial ink printer and roll to roll printing techniques. 3D printers and ink jet printers may also be utilized.

### Nano-Synthetic Cell Construction

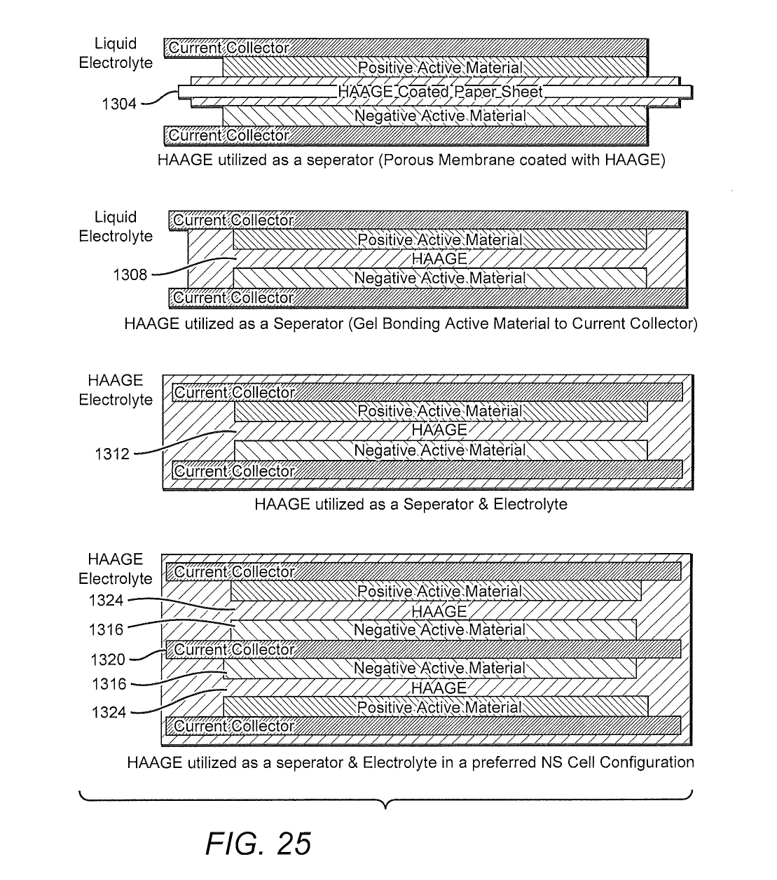

As described previously, nano-synthetic cells can be made of any size, shape, thickness, orientation and stacked in any configuration. Some non-limiting exemplary configurations are shown in FIG. 25, previously described with reference to FIG. 13 in the HAAGE discussion. One method of nano-synthetic cell construction includes a negative electrode with active material on both sides sandwiched by two positive electrodes with active material facing the negative electrode.

Any alkaline electrolyte may be used with the nano-synthetic cell. This may include: KOH (any concentration); NAOH (any concentration); LiOH (any concentration); Sol Gel (any concentration); PAA Gel (any concentration); HAAGE (any concentration); Solid Electrolyte (alkaline) (any concentration); and any combinations thereof.

The cell enclosure or full battery enclosure can utilize any enclosure form described herein. Materials can include (but are not limited to): PVC pipe (with gas valve); plastic enclosure; plastic laminated; PDTE; thin film; etc.

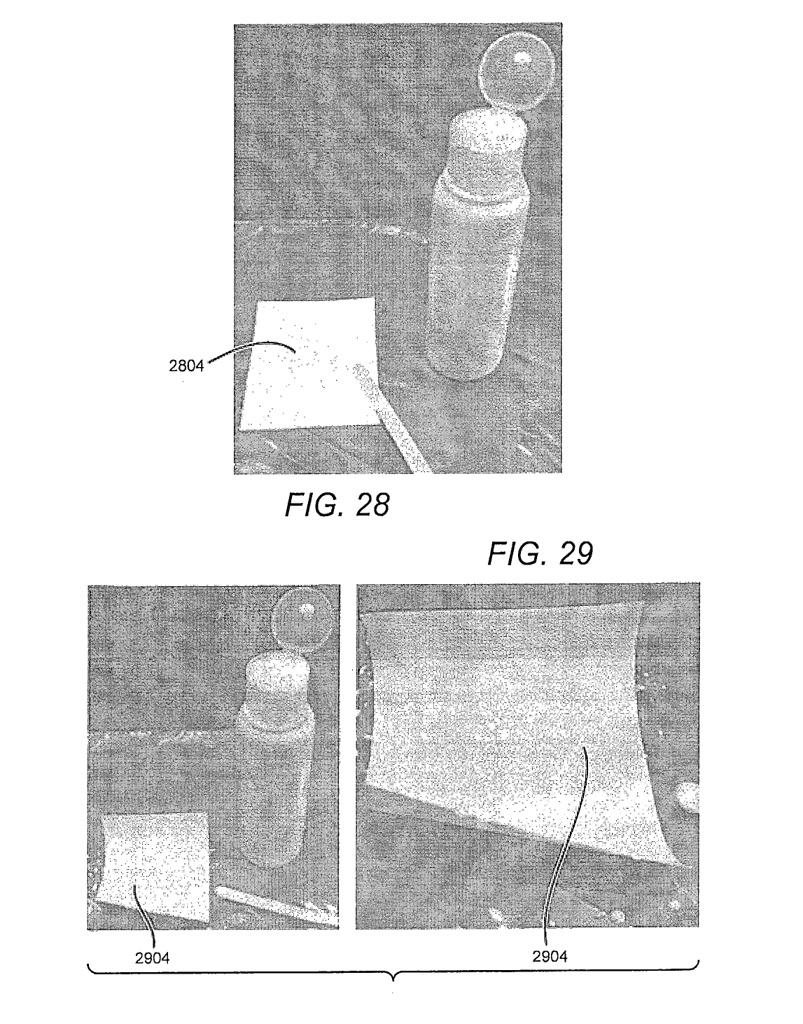

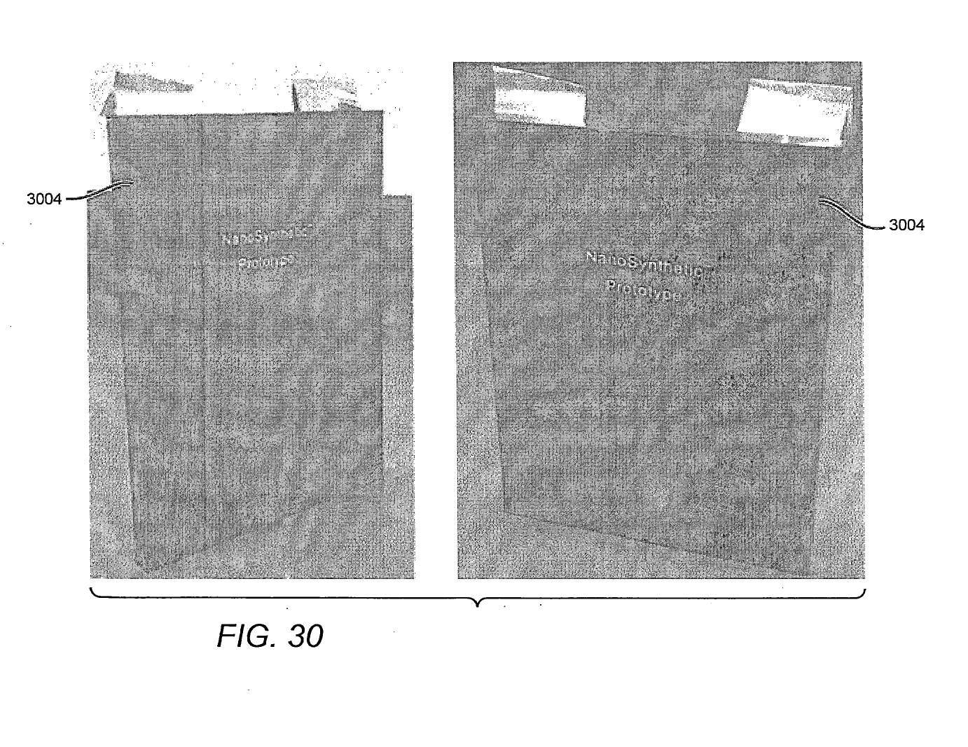

A photo of the HAAGE Electrolyte 2804 after synthesis from the method of the present invention, for optional use in the nano-synthetic cell of the present invention is shown in FIG. 28. A photo of the HAAGE electrolyte coating a separator sheet (e.g. paper sheet) 2904 is shown in FIG. 29. A photo of a nano-synthetic prototype single cell enclosure 3004 having 1.1V Ce11@10AH is shown in FIG. 30.

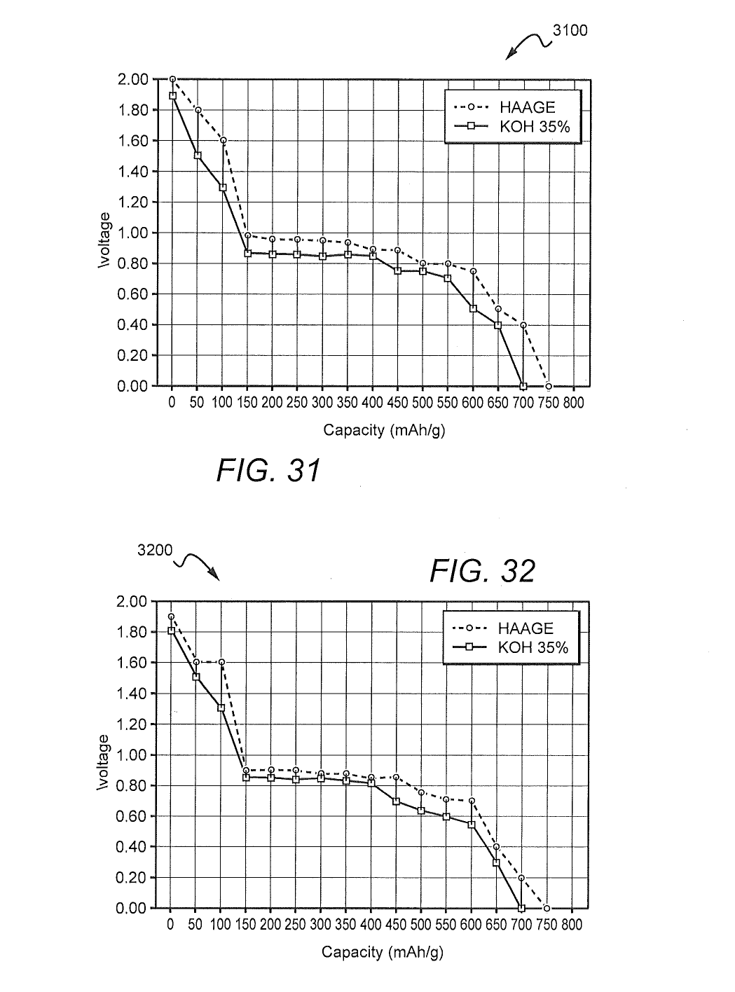

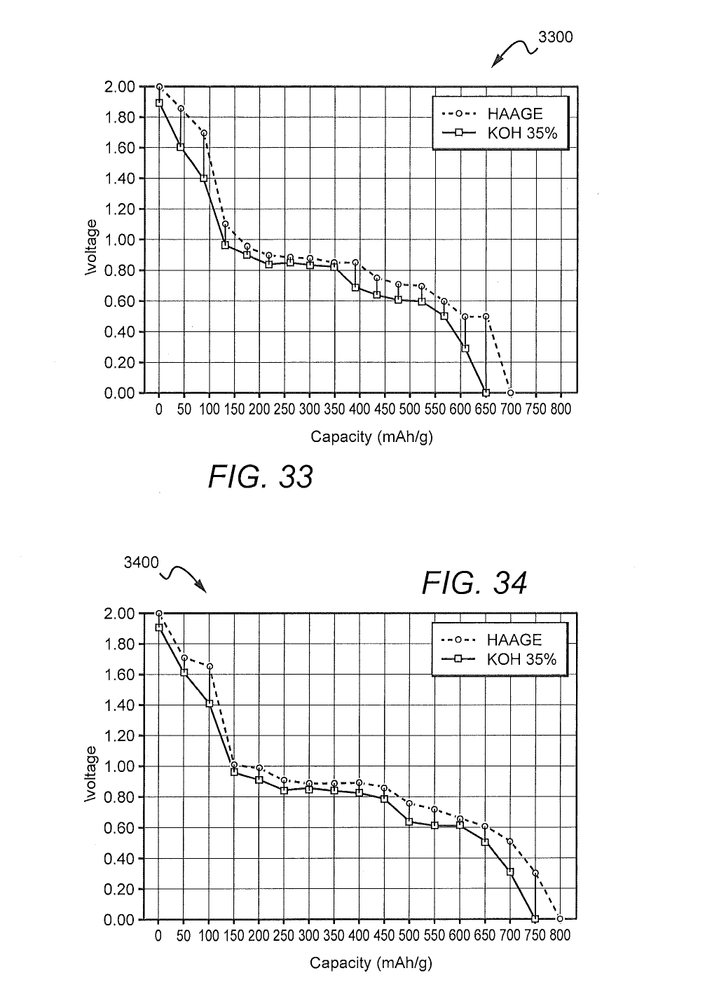

Data for complete discharge of a nano-synthetic cell in accordance with the present invention is provided in FIGS. 31 to 34. FIGS. 31 to 34 show plots of capacity vs voltage for a nano-synthetic battery employing aqueous KOH (35%) and a nano-synthetic battery employing HAAGE made in accordance with the present invention, for various nano-composite active materials. In these tests, the HAAGE electrolyte demonstrates improved performance over the KOH electrolyte. The cells were discharged on a constant resistance load of 500 ohms (average discharge rate of approximately 10 mA/g of active material). FIG. 31 is a graph 3100 showing: CuO/TiO₂ Nano-composite Vs. ZnO/TiO₂ Nano-composite-HAAGE; CuO/TiO₂ Nano-composite Vs. ZnO/TiO₂ Nano-composite-KOH 35%. FIG. 32 is a graph 3200 showing: Cu₂O/TiO₂ Nano-composite Vs. ZnO/TiO₂ Nano-composite-HAAGE; Cu₂O/TiO₂ Nano-composite Vs. ZnO/TiO₂ Nano-composite-KOH 35%. FIG. 33 is a graph 3300 showing: CuO/TiO₂ Nano-composite Vs. Zn/TiO₂ NT-HAAGE; CuO/TiO₂ Nano-composite Vs. Zn/TiO₂ NT-KOH 35%. FIG. 34 is a graph 3400 showing: Cu₂O/TiO₂ Nano-composite Vs. Zn/TiO₂ NT-HAAGE; Cu₂O/TiO₂ Nano-composite Vs. Zn/TiO₂ NT-KOH 35%.

A nano-synthetic cell of the present invention can be made into a variety of shapes, sizes, power densities, voltage stacks, etc. Some of the form factors for the NS cell are shown in a table 1500 illustrated in FIG. 15 and may include: D size (cylindrical, 61.5 mm tall, 34.2 mm diameter); C size (cylindrical, 50.0 mm tall, 26.2 mm diameter); AA size (cylindrical, 50.5 mm tall, 14.5 mm diameter); AAA size (cylindrical, 44.5 mm tall, 10.5 mm diameter); PP3 size (rectangular, 48.5 mm tall, 26.5 mm wide, 17.5 mm deep); and button and coin cells.

The NS cell of the present invention may comprise multiple electrode cells. For example, a monopolar configuration may be used where the battery is constructed form individual cells with external connections joining the cells to form series and parallel chains. For example, a stacked electrode configuration 1604 may be used, as shown in FIG. 16. For example, a bipolar configuration may be used where the cells are stacked in a sandwich construction so that the negative plate of one cell becomes the positive plate of the next cell. Electrodes, often called duplex electrodes, are shared by two series-coupled electrochemical cells in such a way that one side of the electrode acts as an anode in one cell and the other side acts as a cathode in the next cell. The anode and cathode sections of the common electrodes are separated by an electron-conducting membrane which does not allow any flow of ions between the cells and serves as both a partition and series connection.

When a cell is sealed, high internal pressures may build up due to the release of gases and due to expansion caused by high temperatures. As a safety precaution a sealed NS cell may incorporate a safety vent to allow excess pressure to be reduced in a controlled way.

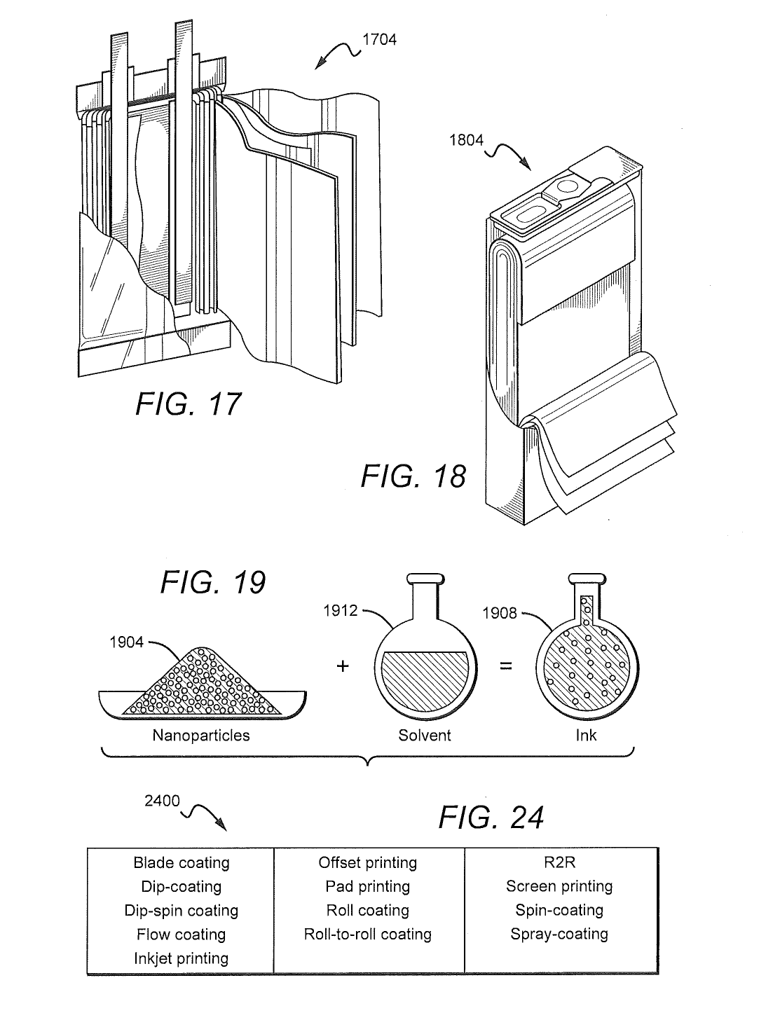

The NS cell of the present invention may be configured in a foil construction 1704, as shown in FIG. 17, which may allow for very thin and light weight cell designs suitable for high power applications. However, because of the lack of rigidity of the casing in a foil construction, the cells may be prone to swelling as the cell temperature rises. Allowance must be made for the possibility of swelling when choosing cells to fit a particular cavity specified for the battery compartment. The cells may also be vulnerable to external mechanical damage and battery pack designs should be designed to prevent such possibilities.

The NS cell of the present invention may be configured as a prismatic cell contained in a rectangular can 1804, as shown in FIG. 18. The electrodes in this configuration are either stacked or in the form of a flattened spiral. They are usually designed to have a very thin profile for use in small electronic devices such as mobile phones. Prismatic cells may provide better space utilization at the expense of slightly higher manufacturing costs, lower energy density and more vulnerability to swelling, but these are minor effects which don't necessarily constitute a major disadvantage.

The NS cell of the present invention may be configured as a flow battery, a rechargeable fuel cell in which the electrolyte of the NS cell comprises one or more dissolved electroactive elements that reversibly convert chemical energy to electricity. The electrolyte may not be stored in the cell around electrodes but may be fed into the cell in order to generate electricity.

Thin film printing technology can be utilized with NS cells for use with a variety of substrates to create unique batteries for specialist applications. Thin film batteries can be deposited directly onto chips or chip packages in any shape or size, and flexible batteries can be made by printing on to plastics, thin metal foil or even paper. Because of their small size, the energy storage and current carrying capacity of thin film batteries is low but they have unique properties which distinguish them from conventional batteries including: an all solid state construction if a solid electrolyte is used; the battery can be integrated into the circuit for which it provides the power; bendable batteries are possible; can be made in any shape or size; long cycle life and operating life; can operate over wide temperature range; may have high energy and power densities; cost and capacity are proportional to the area; and may have no safety problems. Thin film batteries utilizing NS cells of the present invention may have a wide range of uses as power sources for consumer products and for micro-sized applications.

Characteristics of a NS cell of the present invention may include: printable aqueous battery (electrochemical secondary cell); nano-composite battery (electrochemical secondary cell); dual-mode battery (Electrochemical Secondary Cell with 2 voltage windows); fast charge capability; cannot catch fire; and cannot Explode.

In accordance with an aspect of the present invention, the NS cell of the present invention may provide two operational modes: a battery mode, and an extended mode. In the extended mode, the NS cell may maintain a voltage of about 2V to about 1.4V lasting for seconds or minutes depending on capacity of the NS cell. In order to achieve this performance, the NS cell may be charged with about 2.2V or a higher voltage. Extended mode may be achieved when the NS cell voltage reaches about 2V. At about 2V, the NS cell voltage may slowly drop to about 1.1V nominal with no load. Extended mode may have a window of usage right after charge that spans minutes. Extended mode may be useful to specific applications similar to that of super/ultra capacitors. In battery mode, the NS cell may maintain a voltage of approximately 1.1V lasting for several hours' worth of discharge, depending on capacity of the NS cell. The NS cell can be charged with between about 1.3V and about 1.6V to achieve battery mode. Battery mode may be achieved when the NS cell reaches approximately 1.2V. The open cell voltage in battery mode is approximately 1.1V to 1V.

The NS cell may be fast charge capable, typically charging in 6 to 15 minutes depending on capacity. Energy Density of the NS cell was tested to be approximately greater than 400 mA/g. Cycle life of the NS cell was tested to be approximately greater than 10,000 cycles. Round trip efficiency of the NS cell was tested at approximately 93%. Operating temperature of the NS cell was tested at approximately between negative 65 degrees Celsius and 120 degrees Celsius. Discharge abuse tolerance of the NS cell may be high, such that the NS cell may be discharged to 0V on each cycle without any or significant performance degradation.

Nano-synthetic chemistry in accordance with the present invention can be used to produce energy storage devices for a variety of applications in a variety of fields, including (but not necessarily limited to): wind, solar, and renewable energy; power backup for industrial and commercial applications; replacing standard primary batteries; replacing or competing with lead acid and lithium chemistries; grid services, micro-grids and distributed energy applications; and electric vehicle propulsion.

### General

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

Any and all features of novelty disclosed or suggested herein, including without limitation the following:

What is claimed is:

1. An alkaline electrolyte comprising at least a synthesized molecular-mesh of starches infused with transition metal oxide nano-tubes.

2. The alkaline electrolyte of claim 1 wherein the starches comprise modified or reticulated starches.

3. The alkaline electrolyte of claim 1 wherein the transition metal oxide comprises titanium dioxide.

4. The alkaline electrolyte of claim 3 wherein each titanium dioxide nano-tube comprises a one dimensional nano-tube with a tubular structure diameter of approximately 7 nm to approximately 11 nm.

5. The alkaline electrolyte of claim 1 wherein the alkaline electrolyte comprises an aqueous alkaline gel electrolyte.

6. An alkaline battery comprising:
at least one anode;
at least one cathode; and
an alkaline electrolyte comprising a synthesized molecular mesh of starches infused with transition metal oxide nano-tubes;
wherein the alkaline electrolyte separates the at least one anode from the at least one cathode.

7. The alkaline battery of claim 6 wherein the starches comprise modified or reticulated starches.

8. The alkaline battery of claim 6 wherein the transition metal oxide comprises titanium dioxide.

9. The alkaline battery of claim 6 comprising:
at least one anode current collector connected to the at least one anode; and
at least one cathode current collector connected to the at least one cathode;
wherein the at least one anode current collector and the at least one cathode current collector are at least partly immersed in the alkaline electrolyte, the alkaline electrolyte separating the at least one anode current collector from the at least one cathode current collector.

10. The alkaline battery of claim 9 wherein:
the at least one anode comprises at least a first anode and a second anode, and the at least one cathode comprises at least a first cathode and a second cathode;
the first cathode and the second cathode are connected to opposing sides of the at least one cathode current collector; and
each of the first anode and second anode are connected to respective ones of the at least one anode current collector.

11. The alkaline battery of claim 6 wherein the alkaline electrolyte comprises an aqueous alkaline gel electrolyte.

12. An alkaline battery comprising:
an anode;
a cathode; and
a separator material comprising a front side and a rear side, each of the front and rear sides coated with an alkaline electrolyte comprising a synthesized molecular mesh of starches infused with transition metal oxide nano-tubes;
wherein the anode contacts the front side of the coated separator material and the cathode contacts the rear side of the coated separator material, the coated separator material separating the anode from the cathode.

13. The alkaline battery of claim 12 wherein the starches comprise modified or reticulated starches

14. The alkaline battery of claim 12 wherein the transition metal oxide comprises titanium dioxide.

15. The alkaline battery of claim 12 wherein the separator material comprises at least one paper sheet.

16. A method of separating at least one anode and at least one cathode of an alkaline battery comprising:
at least partly immersing the at least one anode and the at least one cathode in an alkaline electrolyte comprising a synthesized molecular mesh of starches infused with transition metal oxide nano-tubes, the alkaline electrolyte separating the at least one anode from the at least one cathode.

17. The method of claim 16 wherein the starches comprise modified or reticulated starches.

18. The method of claim 16 wherein the transition metal oxide comprises titanium dioxide.

19. The method of claim 16 wherein the alkaline battery comprises at least one anode current collector connected to the at least one anode and at least one cathode current collector connected to the at least one cathode, the immersing comprising:
at least partly immersing the at least one anode current collector and the at least one cathode current collector in the aqueous gel electrolyte, the aqueous gel electrolyte separating the at least one anode current collector from the at least one cathode current collector.

20. The method of claim 19 wherein the at least one anode comprises at least a first anode and a second anode, and the at least one cathode comprises at least a first cathode and a second cathode, wherein the method comprises:
connecting the first cathode and the second cathode to opposing sides of the at least one cathode current collector; and
connecting each of the first anode and second anode to respective ones of the at least one anode current collector.
